(19) United States
(12) Patent Application Publication
(10) Pub. No.: US 2011/0120617 A1
(43) Pub. Date: May 26, 2011

(54) SPRAYABLE HOT MELT ADHESIVE FOR THE APPLICATION OF DECORATION TO TEXTILES

(76) Inventors: Juergen Katzenberger, Hockenheim (DE); Christian Schmid, Sinsheim (DE)

(21) Appl. No.: 12/732,390

(22) Filed: Mar. 26, 2010

(30) Foreign Application Priority Data
Nov. 26, 2009 (EP) 09014739.8

(51) Int. Cl. B27N 3/00; C08L 33/20; C08L 31/02; C08L 25/06; C08L 23/06; C08L 75/04; B32B 37/02; B29C 65/72

(52) U.S. Cl. 156/62.2; 524/612; 524/556; 524/577; 524/585; 524/590; 156/60

(57) ABSTRACT

The present invention relates to a method for decorating a substrate comprising the following steps:
a) providing a substrate,
b) spraying an adhesive composition through a template onto at last part of the substrate, the adhesive composition including at least one binding agent and at least one particulate hot melt adhesive,
c) applying at least one decorative material, at least onto the part sprayed with the adhesive composition, and heating.

Moreover, the invention relates to a sprayable adhesive composition and to a kit for implementing the method according to the invention.

### CROSS-REFERENCE TO RELATED APPLICATIONS AND CLAIM TO PRIORITY

This application is related to application number 09 014 739.8, filed Nov. 26, 2009 with the European Patent Office, the disclosure of which is incorporated by reference and to which priority is claimed.

### FIELD OF THE INVENTION

The present invention relates to a method for decorating a substrate. Moreover, the invention relates to a sprayable adhesive composition for carrying out the method according to the invention and moreover a kit for carrying out the method according to the invention.

### BACKGROUND OF THE INVENTION

The use of heat-activated adhesives, in particular hot melt adhesives for the application of decoration, in particular in the field of textiles, is known from the prior art. Here, in an industrial screen printing process, the adhesive is applied to the decoration or to the substrate to be decorated using a screen printing press. The decoration and the substrate are then joined together by the effect of heat by ironing on thermotransfer foil or flock transfer paper using an ironing press. It is a disadvantage with this process that it requires the use of screen printing equipment, and this practically rules out use in the context of the home or hobbies.

Furthermore, decoration objects are known for example in the form of textile patches which are coated with a hot melt adhesive on one side. These patches can therefore be ironed onto a textile substrate.

A disadvantage here is that these patches are only available as pre-produced decorations, and it is not possible to form shapes and colours freely. Therefore, until now it has not been possible for the home user to decorate substrates creatively according to their own ideas.

### SUMMARY OF THE INVENTION

It is the object of the present invention to provide a method and an adhesive formulation with which freely designed decoration of substrates, in particular textiles, is possible by means of an adhesive process, even within the context of the home or hobbies. It should be possible here to apply the decoration using means normally available in the home, and in particular the use of complex equipment is to be avoided.

The object according to the invention is achieved by means of a method for decorating a substrate which comprises the following steps:
a) providing a substrate,
b) spraying an adhesive composition through a template onto at least part of the substrate, the adhesive composition including at least one binding agent and at least one particulate hot melt adhesive,
c) applying at least one decorative material, at least onto the part sprayed with the adhesive composition, and heating.

The knowledge underlying the present invention is that instead of the viscous adhesive formulations and the application of the latter by means of screen printing previously used in large-scale industrial adhesive technology, sprayable adhesive compositions are used which contain a binding agent and moreover a particulate hot melt adhesive. This type of adhesive formulation can be sprayed, for example, from a spray nozzle through a template onto the substrate to be decorated, the binding agent fixing the hot melt adhesive particles provisionally onto the substrate. The decorative material, for example flock transfer paper, which is then applied can be heated on the rear side by means of an iron, a hair dryer or a hot air gun. In this way the hot melt adhesive is activated, and the flocking adhesively bonded to the substrate. After pulling away the flock transfer paper, the flocking only adheres onto the part of the substrate sprayed with the adhesive composition through the template.

With the method according to the invention a plurality of substrates can be provided according to the procedure described above with decorative materials. The only proviso as regards the substrate is that the sprayed on adhesive composition or the hot melt adhesive contained therein adheres to the substrate. The substrate can be, for example, a textile substrate such as items of clothing, interior decorating textiles and similar. Furthermore, paper, cardboard, plastics, metals, glass, wood, stone or ceramics can also be provided with decorative materials.

The templates used for the method according to the invention can be pre-produced templates, e.g. designs produced using punching or cutting technology or lettering and characters. As materials, various synthetic films, in particular made of silicone or teflon, cardboard or similar, can be considered, as can also photographically produced templates with which, for example, the illustration of a photo layer is implemented by means of a printer, in particular an ink-jet printer, or an ink-jet film is printed in black indirectly and serves as a film substitute.

It is also possible for the templates to be produced by the end-user from the aforementioned template materials which are, for example, included with the kit. With this embodiment of the present invention a plurality of partially overlaid figures can be printed onto the template material from which the end-user can choose and cut out the desired ones.

Within the framework of the method according to the invention provision is made such that after the application of the decorative material the corresponding point is heated. One proceeds here such that one heats to above the activation temperature of the particulate hot melt adhesive, i.e. at least to a temperature at which the particulate hot melt adhesive displays its adhesive properties. Depending on the choice of particulate hot melt adhesive these temperature are, for example, 80° C. or more, or also 90° C. or more. Heating can be implemented, for example, by means of a hair dryer or a hot air gun.

In an advantageous further development of the method according to the invention provision is made such that the step of heating is implemented with the exertion of mechanical pressure. The latter can already be exerted before heating and/or during heating. It is also possible to only apply the mechanical pressure after heating provided the particulate hot melt adhesive is still above its activation temperature here. In the simplest case the mechanical pressure can be realised by means of an ironing press, a rotary iron or an iron. By exerting mechanical pressure particularly strong cohesion between the decorative material and the substrate is achieved. Alternatively, the heating can be implemented by means of a hair dryer or a hot air gun and after exceeding the activating temperature of the hot melt adhesive the decorative material can be pressed onto the substrate, for example by means of a rolling pin or a heavy object.

According to one preferred embodiment of the method according to the invention the binding agent of the adhesive composition used comprises an aqueous binding agent dispersion. This is particularly advantageous since when using aqueous binding agent dispersions one can largely dispense with the use of highly volatile solvents. When applying an adhesive composition which contains an aqueous binding agent dispersion it is possible, furthermore, to scatter glitter as a decorative material into the sprayed on adhesive composition which is still moist. Adhesive compositions containing solvents often lose their adhesive properties due to the rapid evaporation of the solvent within a short time, and so it is hardly possible to scatter glitter evenly.

Within the framework of the method according to the invention the template used can be laid onto the substrate to be decorated. This is especially advantageous if particularly sharp edges are desired, whereas with a template spaced apart from the substrate less sharp edges can be produced. The laid on template can, if so desired, be removed again after applying the adhesive composition. It is also possible to also leave the template in place while applying the decorative material, and only remove it after heating the substrate.

A plurality of possibilities can be considered as decorative material. These can be selected from flock transfer paper, metallised and/or coloured thermotranser foils, glitter, plastic particles, metallic particles, glass particles, in particular glass pearls, sand, especially coloured sand and/or pigments.

Within the framework of the method according to the invention it is possible, furthermore, for the sprayed on adhesive composition to be dried before applying the decorative material. This type of drying step can comprise passive drying, i.e. in the simplest case drying of the adhesive at ambient temperature. It is also possible to implement the drying step with a slightly increased temperature. For this purpose the substrate provided with the adhesive can, for example, be placed in a baking oven at low temperature, for example 40 or 60° C.

### DETAILED DESCRIPTION OF THE PREFERRED EMBODIMENT(S)

When using glitter as a decorative material, within the framework of the method according to the invention one advantageously proceeds such that the glitter is scattered into the adhesive composition which is still moist, and before heating at least the part coated with the adhesive is covered with a non-adherent covering. In this way, during heating, for example with an iron, the adhesive is prevented from sticking the surface of the iron. Materials which do not adhere to the adhesive or which can easily be removed from the latter can be considered as a non-adherent coating. These are for example anti-adherent coated coverings such as siliconised papers, silicone films, teflon films or siliconised metal or plastic films or those coated with teflon.

In order to decorate the substrate the individual steps of the method according to the invention can also be implemented a number of times, one after the other, in particular using different templates and/or decorative materials. In this way substrates can easily be decorated very individually and durably.

A further object of the present invention relates to a sprayable adhesive composition for implementing the method according to the invention, containing at least one adherent-adhesive aqueous binding agent dispersion, and at least one particulate hot melt adhesive, the adhesive composition having no adherent-adhesive properties in the dry state at room temperature. Preferably, the aqueous binding agent dispersion used here is adherent-adhesive in the moist state and loses these properties after drying has taken place, i.e. after removing the water. The adherent-adhesive properties develop here in particular due to the filming of the polymer particles during drying.

The adherent-adhesive properties can be checked, for example, by seeing whether touching the part sprayed or coated with the adhesive composition according to the invention with a finger leaves any sticky impression after drying.

An adhesive composition which does not have any adherent-adhesive properties in the dry state at room temperature is understood in particular as meaning one of which the glass transition temperature (T_{g}) is above room temperature, i.e. for example 30° C. or more, in particular 40° C. or more, preferably 50° C. or more, particularly preferably 60° C. or more.

The adhesive compositions used within the framework of the method according to the invention, in particular the adhesive composition according to the invention, are characterised in that the particulate hot melt adhesive can be suspended in the binding agent dispersion. Prior to application the particulate hot melt adhesive can be resuspended by shaking or stirring the adhesive composition.

Binding agent dispersions that can be used for the adhesive composition according to the invention comprise in particular polymers, copolymers and/or terpolymers of acrylonitrile, n-butyl acrylate, styrene, vinyl acetate, ethylene, propylene, butadiene, butylene, acrylic acid ester, polyurethanes and mixtures of the latter.

The content within the aqueous binding agent dispersion is preferably between 10 and 80% by weight, more preferably between 15 and 70% by weight, particularly preferably between 20 and 60% by weight. Adhesive compositions with these binding agent contents lead to sufficient adhesion of the hot melt adhesive particles on a plurality of substrate surfaces.

The solid portion of the binding agent dispersions that can be used within the framework of the present invention is in particular 20-70% by weight, preferably 15-65% by weight, particularly preferably 30-60% by weight.

Adhesive compositions according to the invention can contain in addition to the water contained in the binding agent dispersion further water, for example up to 50% by weight, in particular 5-40% by weight, preferably 10-30% by weight. By using additional water the adhesive composition can be adjusted, in particular with regard to viscosity, to the desired degree so that it can be sprayed using a pressurised aerosol can or some other spraying device with an even result.

According to a further development of the present invention the particulate hot melt adhesive that can be used within the framework of the present invention has an average particle diameter of 200 μm or less, preferably of 150 μm or less, particularly preferably of 100 μm or less. Particularly preferred particulate hot melt adhesives have an average particle diameter of 1 to 150 μm, very particularly preferably 5 to 150 μm. The average particle diameter can be determined by methods known in their own right, for example the determination of a size can be implemented using a scanning electron microscope. Adhesive compositions with particulate hot melt adhesives with these particle sizes can be sprayed particularly evenly. In particular, by restricting the average particle diameter to the aforementioned values, blocking of the nozzle of an aerosol can can effectively be prevented so that these adhesive compositions can readily be sprayed from standard aerosol cans.

Within the framework of the present invention, particulate hot melt adhesives that can be used are principally all hot melt adhesives that can be produced in particulate form, in particular heat-activatable hot melt adhesives. In the simplest case a heat-activatable hot melt adhesive is understood as meaning a hot melt adhesive which upon exceeding the activation temperature becomes reversibly adhesive, and upon falling below the activation temperature loses its adhesive properties again. However, it is also possible to use heat-activatable reactive hot melt adhesives which, after exceeding the activation temperature, pass through a chemical change, in particular undergo a polymerisation or crosslinking reaction. After cooling, when these adhesives exceed the activation temperature there is no renewed fusing; in this respect this process is irreversible.

Thermoplastic hot melt adhesives which have a high softening temperature are in particular suitable as particulate hot melt adhesives (ring and ball method, measured according to DIN 52011). These are non-reactive, solvent-free adhesives which are solid at room temperature, which fuse at increased temperatures, are applied in heat, and upon cooling produce strong adhesion. These hot melt adhesives contain one or more thermoplastic base polymers as well as resins, softening agents and, if so required, other additives and additional materials.

In a particulate hot melt adhesive suitable according to the invention the known thermoplastic base polymers such as polyolefins, in particular polyethylene, ethylene vinyl acetate copolymers, polyamides, polyesters and polyester elastomers, polyurethanes, polyacrylates or styrene copolymers or block copolymers can be used. These polymers are known in principle to the person skilled in the art. The softening temperature can be influenced by the choice of monomers and the molecular weight.

Examples of suitable base polymers are homo- or copolymers based on ethylene and/or propylene and, optionally, further copolymerisable monomers, obtained by means of radical or coordinative polymerisation. The monomers which can be used in addition to ethylene and/or propylene are the known olefinically unsaturated monomers copolymerisable with ethylene/propylene. These are in particular linear or branched C4 to C20-α-olefins such as butene, hexene, methylpentene, octene; cyclically unsaturated compounds such as norbornene or norbornadiene; symmetrically or asymmetrically substituted ethylene derivatives, C1 to C12 alkyl radicals being suitable as substituents. These can be homopolymers or copolymers which can also contain further copolymerisable monomers. Homo/copolymers should also be understood as polymers from more than two monomers. Here the quantity of comonomers should preferably be less than 30%. One embodiment of the invention uses copolymers based on ethylene with C4 to C20-α-olefins. Another embodiment uses polymers from propylene with C4 to C20-α-olefins. Likewise, copolymers based on ethylene and/or propylene are suitable. The latter can also be produced by catalysis with metallocene compounds. These binding agents are often amorphous atactic polyolefins (APAO).

The (co)polymers thus obtained have a molecular weight of 1000 to 200000 g/mol, in particular from 1500 to 50000 g/mol, particularly preferably up to 30000 g/mol (number average molecular weight (MN), determinable by means of gel permeation chromatography). In particular, polymers which have low viscosity at 90 to 180° C. are suitable. These polyolefins are known to the person skilled in the art and can be obtained commercially from various manufacturers.

Furthermore, ethylene vinyl acetate (EVA) copolymers are suitable. These are copolymers based on vinyl acetate and ethylene which can optionally contain further polymerisable monomers. The latter should be crystalline or partially crystalline and have a softening point above 90° C. Here the vinyl acetate content should be 10 to 50% by weight, preferably between 15 and 40% by weight, in particular 18 to approximately 30% by weight.

In addition, further monomers can be contained, polymerised into the EVA polymers, such as for example C3 to C10 unsaturated carboxylic acids, such as acrylic acid, methacrylic acid, crotonic acid, isocrotonic acid; a-β unsaturated C4 to C10 alkylene dicarboxylic acids, such as maleic acid, fumaric acid or itaconic acid. Further monomers which can be polymerised into the EVA are for example C1 to C15 alkyl vinyl esters, C1 to C15 alkyl (meth)acrylate, C1 to C15 alkylesters of dicarboxylic acids, for example such as alkyl fumerate, methyl(meth)acrylate, butyl(meth)acrylate, 2-ethylhexyl (meth)acrylate; C1 to C6 hydroxyalkyl(meth)acrylate, such as hydroxyethyl or hydroxypropyl(meth)acrylate; acrylonitrile, acrylamide, methacrylamide, N-methylol acrylamide. These monomers can be contained in quantities of 0.2 to 10% by weight, in particular up to 5% by weight in relation to the polymer in the EVA polymers. Important functional parameters such as the glass transition temperature (T_{g}), fusion point or softening point can be influenced by the choice of monomers. The molecular weight (MN) of these EVA copolymers is generally between 3000 to 200000 g/mol, in particular up to 100000 g/mol.

These EVA polymers, the methods for producing the latter and suitable comonomers are known to the person skilled in the art. He can select them according to the application technological properties, e.g. the fusion temperature, fusion viscosity, softening point or adhesion properties.

Elastic thermoplastic block copolymers, for example, can also be used. These elastic polymers are to be understood as meaning in particular styrene block copolymers which can have elastic or rubbery-elastic properties. These can be 2 block or 3 block copolymers which have at least one styrene block. Examples of this are SBR, SAN, styrene isoprene copolymers (SIS), styrene ethylene/butylene copolymers (SEBS), styrene ethylene/propylene copolymers (SEPS), styrene isoprene butylene copolymers (SIBS), styrene butadiene copolymers (SBS), hydrogenated styrene, butylene butadiene copolymers (SBBS). These block copolymers are known to the person skilled in the art and are commercially available. The properties of the block copolymers can be influenced by the length of the styrene blocks. These polymers can also be used in particular as mixtures. These products are known to the person skilled in the art and are commercially available.

Also suitable as a particulate hot melt adhesive are, for example, thermoplastic polyesters as can be obtained by converting dicarboxylic acids with corresponding polyfunctional alcohols, in particular difunctional alcohols, for example difunctional polyethers, such as polyethylene oxide. These polyesters are described, for example, in EP-A 028 687. These are conversion products from aliphatic, cycloaliphatic or aromatic dicarboxylic acids which can be converted with aliphatic, cyclical or aromatic polyolene. Crystalline or partially crystalline polyesters can be obtained by the choice of carboxylic acids and polyols. Generally dicarboxylic acids and diols can be brought to react with one another. However, it is also possible for proportionately small quantities of tricarboxylic acids or triols to be used. The polyesters produced should not be crosslinked and should be fusable; linear polyesters are preferred. The molecular weight of suitable polyesters should be between 1500 to 30000 g/mol, in particular between 3000 to 20000 g/mol.

Further suitable hot melt adhesives can be based, for example, on thermoplastic polyamide base polymers. Suitable polyamides are described, for example, in EP-A-749 463. These are polyamide hot melt adhesives based on dicarboxylic acids and polyether diamines. Hot melt adhesives which are likewise suitable are described in EP-A-204 315. These are polyesteramides which are produced based on polymer fatty acids and polyamines. Also used can be block copolymers from polyamides and polyethers which are obtained by the conversion of polyamides substantially linear in structure and terminated with carboxylic functions and/or amine groups based on dimerised fatty acids and aliphatic or cycloaliphatic diamines with substantially linear aliphatic polyethers and/or amines of the latter.

Dimer and polymer fatty acids are those fatty acids which are produced in a known way by dimerising unsaturated, long-chain fatty acids obtained from natural raw materials, are optionally also hydrogenated, and then further purified by distillation. In addition to the dimer and polymer fatty acids the acid component of the polyamide can also contain C4 to C14 dicarboxylic acids. Examples of this type of dicarboxylic acid are maleic acid, succinic acid, adipic acid, azelaic acid, sebacic acid, dodecandiacid, glutaric acid, cork acid, pimelic acid or also aromatic dicarboxylic acids such as, for example terephthalic acid or mixtures.

The diamine component is essentially made up of one or more aliphatic diamines, preferably with an even number of carbon atoms, the amino groups being at the ends of the carbon chains. The aliphatic diamines can contain 2 to 20 carbon atoms, it being possible for the aliphatic chain to be linear or slightly branched. Furthermore, the amino component can contain cyclic diamines or heterocyclic diamines, such as for example 1,4-cyclohexanediamine, 4,4′-diaminodicyclohexylmethane, piperazine, cyclohexane-bis(methylamine), isophorone diamine, dimethylpiperazine, dipiperidyl propane, dimer-diamine (amines produced from dimer fatty acids). For example, types of nylon, for example nylon-6,6, nylon-6,9 or nylon-6,12, can also be used as a hot melt adhesive.

The particulate hot melt adhesive suitable according to the invention must contain at least one base polymer. It is also possible to use mixtures of polymers. Since the polymers substantially effect the properties of the hot melt adhesive, the fusion point of the base polymers and their mixtures should be from 80 to 200° C., in particular above 100° C. and below 160° C. In addition, the hot melt adhesive can contain further components.

A suitable hot melt adhesive can contain at least one resin. The resin brings about additional adhesiveness and improves the compatibility of the hot melt adhesive components. These are in particular resins which have a softening point of 70 to 140° C. (ring and ball method, DIN 52011). These are for example aromatic, aliphatic or cycloaliphatic hydrocarbon resins as well as modified or hydrogenated versions of the latter. Further suitable resins are hydroabietyl alcohol and its esters, preferably modified natural resins, such as resin acids from balsam resin, tall oil resin or root resin, terpene resins, in particular copolymers of terpene, and hydrogenated derivatives of the latter; acrylic acid copolymerisates and conversion products based on functional hydrocarbon resins.

The resin has a low molecular weight of below 2000 g/mol, in particular below 1500 g/mol. It can be chemically inert or it can optionally also contain functional groups such as for example OH groups, carboxylic groups or double bonds. The quantity of resin should be between 0 to 40% by weight in relation to the hot melt adhesive, in particular 5 to 30% by weight.

The softening point of the particulate hot melt adhesives used according to the invention should be above 80° C., preferably above 90° C., but it is mostly below 150° C., in particular below 130° C. If the softening point is too high, after fusing there is generally no suitable viscosity. If the softening point is too low, the adhesion between the decorative material and the substrate is not stable with increased ambient temperature or upon washing in a washing machine in the case of textiles.

The adhesive compositions can have a particulate hot melt adhesive content of 10 to 60% by weight, preferably from 12 to 55% by weight, in particular from 15 to 50% by weight. Adhesive compositions with this particulate hot melt adhesive content are able, even with small quantities of the adhesive composition applied to a substrate, to produce a sufficiently secure bond to the decorative material after heat activation of the hot melt adhesive.

According to a further preferred embodiment of the adhesive composition according to the invention the latter contains even further ingredients which are chosen from dispersion additives, defoamers, surfactants, colorants, stabilisers, rheology additives, softeners, conservation means and/or resins providing adhesion. With the aid of these ingredients the desired properties of the adhesive composition can be obtained.

Dispersion additives usable according to the invention are in particular ethoxylated fatty alcohols which are preferably included in the adhesive compositions according to the invention with a content of up to 6% by weight.

Non-ionogenic solids, hydrophobic silicic acid and white oil, for example, can be considered as defoamers.

Preferably used as surfactants are siloxane-based surfactants, for example with a content of 0.1 to 1.5% by weight in relation to the overall composition of the adhesive composition according to the invention.

Colophonium resins and derivatives of latter are used in particular as resins providing adhesion.

As rheology additives, in principle all known means such as e.g. bentones, pyrogenic silicic acids, urea derivatives, polyamide wax or hardened fatty acid derivatives in quantities of 0 to 4% by weight in relation to the overall composition of the adhesive composition according to the invention can be used.

Conservation means can be used in quantities of up to 0.2% by weight. Preferably less than 0.1% by weight in relation to the overall composition of the adhesive preparation or no conservation means are used.

According to one particularly preferred embodiment the adhesive composition according to the invention is free from highly volatile organic solvents with a boiling point of over 25° C. and lower than 200° C., in particular of over 25° C. and lower than 150° C. Dispensing with these highly volatile organic solvents makes the handling of these adhesive compositions safer in relation to damage to health or a possible fire risk which can derive from these types of organic solvent. This is particularly relevant because the adhesive composition according to the invention should also be used within the domestic context, i.e. with users who are not generally trained in dealing with hazardous substances.

According to a further development of the adhesive composition according to the invention the latter has a viscosity of up to 6000 mPas, in particular up to 3000 mPas, preferably up to 1000 mPas, more preferably of 20 to 700 mPas, particularly preferably 30 to 500 mPas, and very particularly preferably 50 to 400 mPas. This is particularly advantageous since adhesive compositions with the viscosities specified above enable easy sprayability in conventional aerosol cans.

When pressurised cans or aerosol cans are filled with the adhesive composition according to the invention, the adhesive composition can be subjected to a propellant gas.

The present invention further relates to a kit for implementing the method according to the invention containing at least the following components:
an adhesive composition which contains at least one binding agent and at least one particulate hot melt adhesive, in particular an adhesive composition according to the invention,
at least one template and/or a template material, and
at least one decorative material and, if so desired,
a non-adherent covering.

This type of kit is particularly advantageous because it contains all of the materials required in order to implement the method according to the invention.

According to one preferred embodiment of the kit according to the invention the latter contains printed instructions, or instructions given on a data carrier, for implementing the method according to the invention.

According to a further preferred embodiment of the kit according to the invention the adhesive composition is located in a pressurised can which is filled with a propellant gas. The propellant gas is preferably chosen from dimethyl ether, tetrafluorethane, in particular 1,1,1,2-tetrafluorethane or 1,1,2,2-tetrafluorethane, carbon dioxide, nitrogen and/or compressed air.

### Examples

In the following the present invention is described in greater detail by means of a few exemplary embodiments.

In the following table compositions of four sprayable adhesive compositions according to the invention are respectively specified in % by weight.

| | A | B | C | D |
|---|---|---|---|---|
| Aqueous dispersion of an acrylic | 6.6 | 27.2 | 25.0 | 26.1 |
| acid ester copolymerisate (binding | | | | |
| agent) | | | | |
| Copolyamide fusion power, average | 26.6 | 31.9 | | 34.8 |
| particle diameter <= 65 μm (parti- | | | | |
| culate hot melt adhesive) | | | | |
| Polyurethane fusion powder, aver- | | | 29.2 | |
| age particle diameter <= 80 μm | | | | |
| (particulate hot melt adhesive) | | | | |
| Ethoxylated fatty alcohol (dispersion | 0.3 | | 0.4 | 0.4 |
| additive) | | | | |
| Mixture of modified alcohols and of | 0.1 | 0.2 | 0.2 | 0.2 |
| a polysiloxane adduct (defoamer) | | | | |
| 1,1,1,2-tetrafluorethane (propellant | 50 | | | |
| gas) | | | | |
| Dimethylether (propellant gas) | | 9.1 | 16.7 | 13.0 |
| Water | ad. 100 | ad. 100 | ad. 100 | ad. 100 |

Production of Adhesive Compositions A to D According to the Invention

In order to produce the adhesive compositions according to the invention the aqueous dispersion of the acrylic acid ester copolymerisate (Lipton AE 4522 or Plextol DV 370) was respectively presented and the dispersion additive (Mirox MD) and the defoamer (Dehydran 1620) were added while stirring. After 10 minutes stirring, while still stirring the water and then the particulate hot melt adhesive (Griltex 1500 A or Griltex 2 A or Schaetti Fix 234 V) were added and stirred for a further 30 minutes. The adhesive compositions produced in this way were then poured into aerosol containers, sealed with a valve and then the specified quantity of propellant gas was applied.

The compositions thus produced are stabile in storage and are still sprayable, even after a long storage period.

Plextol DV 370 is an aqueous dispersion of a copolymerisate of acrylonitrile, n-butylacrylate and styrene.

Lipaton AE 4522 is an aqueous dispersion of a copolymerisate of n-butylacrylate and styrene.

Griltex 1500 A and Griltex 2 A are particulate hot melt adhesives based on copolyamide with an average particle diameter of up to 65 μm (A) or up to 35 μm (2A).

Schaetti Fix 234 V is also a particulate hot melt adhesive based on polyurethane with an average particle diameter of up to 80 μm.

Method for Decorating:

In the following the method for decorating textiles with a thermotransfer foil or flock transfer paper with the aid of the above-specified adhesive compositions is described.

First of all a template in the desired form is produced from cardboard, and the textile to be decorated, which is a cotton textile, is laid on top. The adhesive compositions described above, and with which aerosol containers are filled, are sprayed through the template onto the textile and dried at room temperature. Then the template is removed and a thermotransfer foil or the flock transfer paper is laid with the functional side on the adhesive and heated with a conventional iron, and thus transferred.

Examination and Assessment of Wash Resistance:

In order to examine and assess the wash resistance the cotton textiles decorated with the synthetic compositions A to D specified here are washed in a conventional washing machine at 60° C. and the effect of the washing process upon the decoration is assessed optically by visual inspection. After washing, no discernable change occurs after washing. All of the decorations are wash-resistant at 60° C.

Decoration of a Cotton Textile with Glitter:

In the following the decoration of a cotton textile with glitter is described. For this purpose a template is produced in the way described above and laid onto the cotton textile, and the adhesive compositions A to D are each sprayed separately onto the textiles. Glitter is scattered into the adhesive which is still wet, and the adhesive is then dried at room temperature.

In order to fix the decoration a silicone paper is laid with the siliconised side over the adhesive scattered with glitter and ironed on with a conventional iron. The textiles decorated in this way are also wash-resistant at 60° C.

We claim:

1. A method for decorating a substrate comprising the following steps:
a) providing a substrate,
b) spraying an adhesive composition through a template onto at least part of the substrate, the adhesive composition including at least one binding agent and at least one particulate hot melt adhesive,
c) applying at least one decorative material, at least onto the part sprayed with the adhesive composition, and heating.

2. The method according to claim 1, characterised in that the binding agent of the adhesive composition comprises an aqueous binding agent dispersion.

3. The method according to claim 1, characterised in that the template is laid onto the substrate and, if so desired, removed again after applying the adhesive composition.

4. The method according to claim 1, characterised in that the decorative material is chosen from flock transfer paper, metallised and/or coloured thermotransfer foils, glitter, plastic particles, metallic particles, glass particles, in particular glass pearls, sand, especially coloured sand and/or pigments.

5. The method according to claim 4, characterised in that the glitter is scattered into the adhesive composition which is still moist, and before heating at least the part coated with the adhesive is covered with a non-adherent covering, preferably with an anti-adherent-coated covering, in particular with a siliconised paper, with a teflon or silicone film or a siliconised metal or plastic film.

6. A sprayable adhesive composition for implementing a method according to claim 2, containing at least one aqueous binding agent dispersion and at least one particulate hot melt adhesive, in the dry state at room temperature the adhesive composition having no adherent-adhesive properties.

7. The adhesive composition according to claim 6, characterised in that the aqueous binding agent dispersion comprises polymers and/or copolymers of acrylonitrile, n-butyl acrylate, styrene, vinyl acetate, ethylene, acrylic acid ester, polyurethanes and mixtures of the latter.

8. The adhesive composition according to claim 6, characterised in that the aqueous binding agent dispersion content is between 10 and 80% by weight, in particular between 20 and 60% by weight.

9. The adhesive composition according to claim 6, characterised in that the solid portion of the binding agent dispersion is 20 to 70% by weight.

10. The adhesive composition according to claim 6, characterised in that the average particle diameter of the particulate hot melt adhesive is 200 μm or less, in particular 100 μm or less, preferably 1 to 150 μm.

11. The adhesive composition according to claim 6, characterised in that the particulate hot melt adhesive is chosen from polyolefins, in particular polyethylene, ethylene vinyl acetate copolymers, polyamides, polyesters or polyester elastomers, polyurethanes, polyacrylates or styrene copolymers or block copolymers.

12. The adhesive composition according to claim 6, characterised in that the particulate hot melt adhesive content is 10 to 60% by weight, in particular 15 to 50% by weight.

13. The adhesive composition according to claim 6, characterised in that the adhesive composition contains further ingredients which are chosen from dispersion additives, defoamers, surfactants, colorants, stabilisers, softeners, conservation means and/or resins providing adhesion, in particular colophonium resins.

14. The adhesive composition according to claim 6, characterised in that the adhesive composition has a viscosity of up to 6000 mPas, preferably up to 1000 mPas, in particular from 20 to 700 mPas, preferably 30 to 500 mPas, particularly preferably 50 to 400 mPas.

15. A kit for implementing a method according to claim 1, containing at least the following components:
an adhesive composition which contains at least one binding agent and at least one particulate hot melt adhesive, in particular an adhesive composition according to any of claims 6 to 14,
at least one template and/or a template material, and
at least one decorative material and, if so desired,
a non-adherent covering.
